(19) United States
(12) Patent Application Publication
(10) Pub. No.: US 2009/0274257 A1
(43) Pub. Date: Nov. 5, 2009

(54) APPARATUS FOR GENERATING NUCLEAR REACTIONS

(76) Inventor: A. Christian Tahan, Cambridge, MA (US)

Correspondence Address: Chris Tahan, PO Box 391987, Cambridge, MA, 02139, US

(21) Appl. No.: 12/361,540

(22) Filed: Jan. 28, 2009

Related U.S. Application Data
(63) Continuation-in-part of application No. 10/537,532, filed on Jun. 3, 2005, now abandoned.

(51) Int. Cl. G21G 1/00

(52) U.S. Cl. 376/156

(57) ABSTRACT

Subatomic particles enter an atom at room temperature when the atom is held in a sufficiently strong magnetic field involving exposure to low frequency electromagnetic energy. The result is the release of particles, the generation of new bodies, including isotopes, and/or the release of energy.

### RELATED APPLICATIONS

This application is a continuation in part of U.S. patent application Ser. No. 10/537,532 filed Dec. 23, 2002.

### FIELD OF THE INVENTION

This invention relates to a new method of generating nuclear reactions, including subjecting elements in the presence of a magnetic field to low frequencies for the production of isotopes or release of energy. The process, in one embodiment, involves the converting of free Hydrogens to neutrons.

### BACKGROUND OF THE INVENTION

The capture of nucleons by elements has been well examined and also observed in Nature. Neutron capture has been often achieved in the laboratory. But the primary difficulty is to stimulate the capture, i.e. to produce free neutrons for the capture to be possible. Neutrons are generally known, as described in the online Wikipedia article “Neutron,” to be produced only from nuclear disintegrations, nuclear reactions, and high-energy reactions (such as in cosmic radiation showers or accelerator collisions). In other words, many particles need to be created in high energy particle accelerators or are found in cosmic rays.

E. Fermi in U.S. Pat. No. 2,206,634 provided specific production methods for neutrons by “the action of radon on beryllium or of polonium on beryllium or by bombardment of atomic nuclei with artificially accelerated particles.” Fermi indicated that the methods produce neutrons with a wide range of energies but high average energy so that his patent describes converting high energy neutrons to low energy (slow or thermal) neutrons. Specifically, the probability for capture is great for slow neutrons; capture for fast neutrons is small but observable.

### SUMMARY OF THE INVENTION

Application of low frequency electromagnetic energy to Hydrogen in a magnetic field was found to produce neutrons, in one embodiment p+e⁻→n, νₑ, which permitted a neutron capture nucleosynthesis, concluded from the detections of various isotopes. The process is effective at room temperature.

The invention involves atoms, a subatomic particle source, magnetic field, a holding vessel for the subatomic particle source and atoms held in the magnetic field, and a source of low frequency electromagnetic energy. In one embodiment, the Hydrogen source used for the majority of work is concentrated (typically 98% grade) sulfuric acid. The holding vessel is a Pyrex tube (No. 9825). However, a graphite tube (Crucible, Saed/Manfredi G40, 1.5″OD×1.25″ID×3.75″DP) can be used for increased effectiveness in creating new elements. Specifically, the Pyrex and graphite tubes serve as neutron reflectors, which prove effective in production of isotopes as detected with primarily Inductively Coupled Plasma Mass Spectroscopy (ICP-MS) and a Germanium detector. The graphite was a better neutron reflector so that any improved means for directing subatomic particles to the holding area for the atoms allows for greater effectiveness for the subject process. Element production was not easily observed when using tubes (VWR scintillation vials) that were made of non-neutron reflective material. Specifically, production of isotopes not initially in the holding vessel was not detected or was in small concentrations to prevent facile detection.

Use of the Pyrex tube involved the insertion of a Copper wire (22-gauge) for carrying a low frequency signal directly in the acid. The wire (antenna) was inserted to the bottom of the tube, ≈0.027 m in the liquid. The tip is immersed in element powder inserted into the Pyrex tube for producing isotopes from a specific element. In one experiment Tungsten powder was used for many trials. Trials were run with 2 Hz (Vₚ₋ₚ≈12-12.5V) for the majority of Pyrex tube trials using one antenna. Multiple antennas could be inserted in the medium, but the amplitude would have to be decreased. In one embodiment 12-12.5V was effective since the apparatus originally had current leaving the vessel through an additional wire in the tube. However it was found that the wire served no significant purpose and was eventually removed for convenience. Accordingly, the required amplitude for the subject invention decreased to about 11.5V.

The required amplitude varies based on the number of wires inserted in the tube, apart from the type of tube used and volume and type of subatomic particle source. Thus, different amplitudes were tested based on alterations of the set-up. The duration of trials depended on what elements were to be produced or for the release of specific particles or energy. For instance, more nucleon capture would occur the longer trials were run.

In one embodiment, the Pyrex or graphite tube was ≈0.01-0.012 m from the S pole of the magnet used. But the main focus was simply to be certain that the placement of the tube was in the region of the magnet measuring 2000 Gauss (Gs). This certainty was established with a Gauss meter (FW Bell Gauss/Teslameter Model 5080). Initially, a gap magnet (General Electric type 15A 270) was used since it would permit insertion of tubes between the poles. Later experiments using one magnet or magnetized disc regardless of whether it was a North or South pole, with only magnetic strength being the concern, lead to isotope production. Any type of magnet could be used if the magnet is large enough to allow for contents of the holding vessel to be exposed to it in close proximity.

Since graphite is a conductor, the current is applied to the acid by clipping alligator clips carrying the low frequency signal to the upper edges of the graphite tube, with the alligator clips not in contact with the acid. In an early embodiment, wires were inserted directly in the acid carried by the graphite tube to provide the low frequency signal, which was also effective for isotope production. The move to alligator clips was for commercialization purposes.

The Hydrogens were separated from the sulfuric acid primarily with electrolysis. Bubbles were not observed suggesting that the majority of the Hydrogens were held aligned with the magnetic field, thereby reducing the possibility of the formation of Hydrogen gas. Any sufficient supply of free Hydrogens can replace the acid source.

Electrolysis was confirmed by producing Copper (II) sulfate (CuSO₄) by inserting Copper powder in the tube, with the acid turning a blue color due to the application of the low frequency signal, as would be expected with CuSO₄ production. The current from using a fixed frequency and amplitude signal was low, e.g. 0.05 mA. It will be appreciated that the subject invention includes the use of direct current.

The Copper (II) Sulfate was produced when using the graphite tube and the alligator clips. Since energy measurements related to isotopes that were being produced were recorded with a Germanium detector when using the graphite tube and the alligator clips, electrolysis was concluded the primary method of separating Hydrogens. In other words, no metal contact with the acid existed when using the alligator clips so that any isotope production was due only to the influence of the low frequency signal while the acid was in the magnetic field. Without the magnetic field, isotope production or the release of energy was not detected.

2 Hz was the most reliable frequency no matter the type of tube used. The amplitude depended on the tube used, the volume of acid or type of nucleon source in the tube, and the manner the low frequency signal was applied to the nucleon source. For example, with the graphite tube when using the alligator clips, Vₚ₋ₚ≈4-4.375V was effective in the production of isotopes. In one embodiment 20 mL was used in the graphite tube, while 2 mL of acid was used most for Pyrex tubes.

Different magnetic fields can be utilized, though a 2000 Gs magnetic field is preferred. For instance, 1000 Gs proved effective, used with the graphite tube, alligator clips, a 2 Hz frequency signal with a 4.375V amplitude. However, the magnetic field strength should not be too low so that elements as Hydrogens cannot align in the magnetic field and cannot be too great, whereby the potential energy of elements would be too high due to the influence of the field. Consequently, the energy from the low frequency signal and associated amplitude would have little affect.

2 Hz appeared to be the most reliable frequency for producing nuclear reactions. However, overtones were observed to produce nuclear reactions. For example in one study when using the 2000 Gs magnet, 2 Hz, 2.5 Hz, 4 Hz, and 5 Hz were effective in creating isotopes, while isotope production was not readily detected at 0.5 Hz, 1 Hz, 3 Hz, 3.5 Hz, and 6 Hz. Thus, 2 Hz was concluded to be a fundamental frequency. Also, the magnetic field strength influenced what frequencies would work. For instance at 1000 Gs, 3 Hz was effective, though 3 Hz had not been detected to be effective at 2000 Gs. Specifically, different magnetic fields can have dissimilar affects on different nuclei so that multiple frequencies can be considered useful for the invention. One scenario if using magnetic field and frequency sources that can be altered with dials is that an effective field strength (2000 Gs) and frequency (2 Hz) can be used to produce neutrons, after which a more effective magnetic field strength (1000 Gs) and frequency (3 Hz) can be selected to produce isotopes utilizing the produced neutrons. However, maintaining a fixed magnetic field (2000 Gs) and frequency (2 Hz) is sufficient for the invention.

The subject invention has the advantage of having the initial element for producing other isotopes immersed in the nucleon source versus being isolated separately in a position to be bombarded by particles or nucleons, as has been typical for isotope productions with Cyclotrons, nuclear reactors, or with a different laboratory method. The immersion requires fewer nucleons to produce new isotopes since interaction of the initial element with nucleons is more likely, particularly if, in the case of neutron capture, the holding vessel is a neutron reflector. Specifically, neutron capture is more likely since the initial element is immersed in a medium of the interacting nucleons rather than being bombarded with the hope that a certain number of nucleons or particles will hit the target element to create new isotopes. Thus, the subject invention permits the creation of isotopes or nuclear reactions with a lower neutron flux than would be classically expected.

Regarding neutrons, one reason for the success in creating isotopes is that apart from the technique of subjecting Hydrogen in a magnetic field to low frequency energy to produce slow neutrons, the acid medium acts as a moderator so that the set-up, especially when using a neutron reflecting holding vessel, is a novel form of nuclear reactor that is safer compared to previously designed graphite reactors. For example, the nuclear processes occurring in the holding vessel will slow and stop when the low frequency signal is turned off. An additional advantage is that the invention can be portable, especially if the low frequency signal is from a circuit that can be plugged in or can be run on a battery. The size of the subject apparatus can be scaled larger, making the subject invention suitable for a fixed installation, for greater productions of nuclear reactions, isotopes, or release of energy. The acid medium further slowing down neutrons makes capture more likely especially when an initial element is well dispersed, in one embodiment as a powder, in the medium. Accordingly, fission is possible depending on the initial element immersed in the nucleon source in the holding vessel. However, insertion of the initial element can vary. For instance, capsules can be designed for holding the initial element when in the nucleon medium to permit easier removal when needed.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the apparatus when the frequency source is an antenna inserted in the holding vessel;

FIG. 2 is a diagrammatic illustration of the apparatus when the frequency source is connected to the holding vessel and not inserted in the medium of the vessel;

FIG. 3 is a diagrammatic illustration of the apparatus in an enclosure incorporating a door for inserting holding vessels, atoms, or nucleon sources with the interior engineered to hold numerous vessels for multiple productions to increase output;

FIG. 4 is a diagrammatic illustration of a circuit to provide the low frequency signal that can be incorporated with any form of the invention and may include IC sockets for increasing the number of antennas carrying frequency from it, binding posts to allow for the connection of alligator clips to carry frequency away from the circuit, and battery holders to run the invention on battery power if a power outlet is unavailable;

FIG. 5 is the output from a Germanium detector showing the energy peak related to the creation of the isotope Cu-64 when using a 2000 Gs magnetic field, graphite tube, and 2 Hz;

FIG. 6 is the output from a Germanium detector showing the energy peaks related to the creation of the isotope Li-6 when using a 1000 Gs magnet, a 3 Hz signal and a graphite tube;

FIG. 7 is output from Differential Thermal Analysis of a collected sample showing the production of an element high on the periodic table;

FIG. 8 is output from ICP-MS gathered by an independent lab at the Massachusetts Institute of Technology (MIT) that were hired to analyze samples from the machine and reported data confirming the effectiveness of the subject process and apparatus;

FIG. 9 is an example separation kit that can be used to isolate specific particles or elements removed from the apparatus for specific functions;

FIG. 10 is output from a Germanium detector showing an energy reading related to the production of Helium-4;

FIG. 11 is output from a Germanium detector showing an energy reading related to the production of Oxygen-18;

FIG. 12 is output from a Germanium detector showing an energy reading related to producing deuterium;

FIG. 13 is output from a Germanium detector showing an energy reading related to the binding energy per nucleon for deuterium;

FIG. 14 is output from a Germanium detector showing an energy reading related to the production of Helium-3;

FIG. 15 is output from a Germanium detector showing an energy reading related to the decay of Nitrogen-13;

FIG. 16 is output from a Germanium detector showing an energy reading related to an additional production with Helium-3 but with a different magnetic field strength than the production illustrated in FIG. 14;

FIG. 17 is output from a Germanium detector showing an energy reading representing the binding energy per nucleon for Carbon-12;

FIG. 18 is output from a Germanium detector showing an energy reading representing the detection of the isotope Platinum-199;

FIG. 19 is output from Energy Dispersive Spectroscopy (EDS) of the Tungsten (W) powder used for trials compared to a W source of known purity; and,

FIG. 20 is additional output from ICP-MS gathered by an independent lab at MIT that confirmed that new bodies were produced when using a neutron reflective holding vessel.

### DETAILED DESCRIPTION

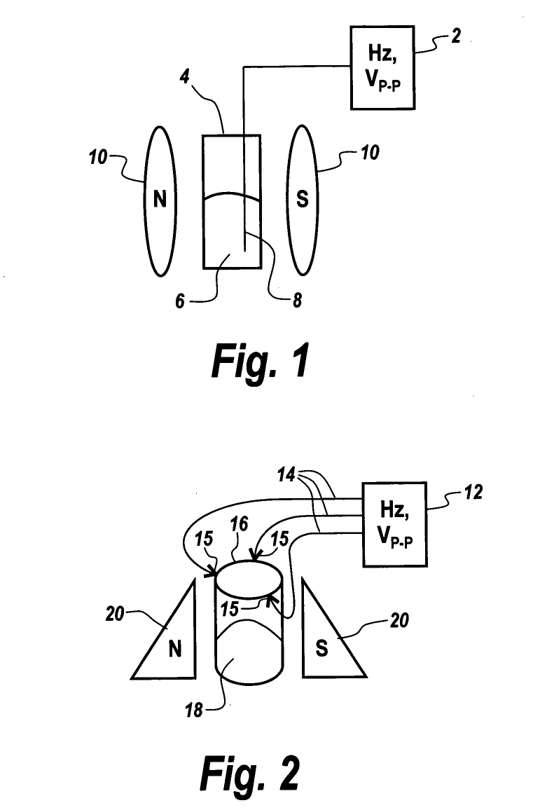

Referring now to FIG. 1, the ability to generate nuclear reactions requires atoms and a subatomic particle or nucleon source 6 contained in a holding vessel 4 in a magnetic field 10. Low frequency electromagnetic energy is produced by a circuit or function generator 2 and is delivered to the atoms and nucleon source in the holding vessel with a wire or antenna 8 (e.g. 22-gauge Copper wire). The antenna 8 is ≈0.027 m in the subatomic particle source, e.g. concentrated sulphuric acid, and it is ≈0.01-0.012 m from the S pole, where the magnetic field strength is ≈2000 Gs. The wire is not touching the holding vessel, a Pyrex tube having been used in set-ups as FIG. 1, and the wire carries the 2 Hz signal.

Referring now to FIG. 2, the invention set-up can be altered as long as a sufficiently strong magnetic field 12, a subatomic particle source and atoms 18, a holding vessel 16, and low frequency electromagnetic energy delivered to the particle source and atoms are used. The different shape of the magnet in FIG. 2 is to illustrate that the concern is the magnetic field strength and the ability to expose contents of the holding vessel to the field. It has been found that the specific shape of the magnet does not matter. The electromagnetic energy is produced with a circuit or function generator 12 in FIG. 2, but for convenience the low frequency signal is delivered with multiple wires 14 that do not enter the vessel but are instead attached to the upper edge of the tube with alligator clips 15. Also, the case of multiple wires simply indicates that more than one wire was tried for the invention and was found to be effective. It has been found that the number of connecting wires is not a significant issue as long as an amplitude of 4-4.375V is used to produce isotopes in the FIG. 2 set-up. The tube used for the FIG. 2 set-up is the graphite tube mentioned previously positioned at the 2000 Gs region of the magnetic field. In other words, field strength varies slightly depending on location between the magnet poles. A measure of 2000 Gs was 0.01 m from the S pole. Sulfuric acid continued to be the nucleon source, and atoms were inserted in the tube depending on the nuclear reactions that were desired. For instance, if production of Cu-64 was desired, Cu-63 was added to the sulfuric acid in the vessel.

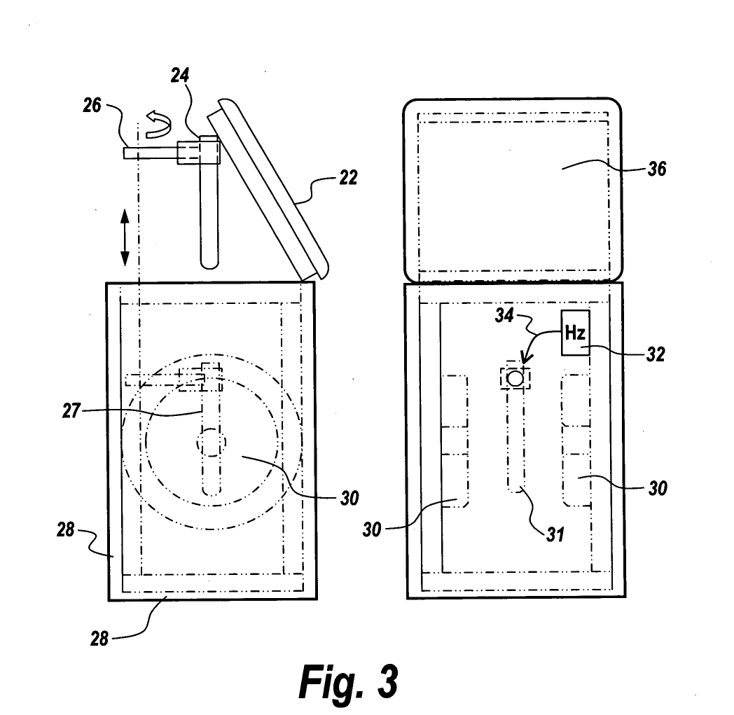

Referring now to FIG. 3, the subject invention is presented as incorporating an enclosure of half inch thick walls encased in steel 28 with a swing open door 22. The walls can contain specific materials for preventing particularly produced bodies from escaping. The lead enclosure is a commercial modification used as a safety measure to protect users from excess exposure of released energy. In one embodiment, FIG. 3 is 12″×12″×12″ and weighs roughly 220 lbs. The components of the invention are maintained with the existence of a magnetic field with a magnet 30. The holding vessel 24 is inserted in the enclosure with a robotic arm 26 that rotates and lowers so that the vessel can be inserted to the level of the magnetic field 27 and removed with the user having little exposure to contents of the vessel.

FIG. 3 shows two versions of the subject apparatus, one with a door as the roof 22 of the apparatus and the other with a door that can swing open or slide 36 on the front of the enclosure. The front door version allows for a more direct interaction by the user, as for inserting holding vessels with specimens 31. A circuit 32 that can deliver a low frequency signal to the tube and contents is illustrated, with the low frequency signal delivered with a wire and alligator clip 34 attached to the top of the tube. The placement of the tube never changes, a location that has the desired magnetic strength. Multiple tubes can be inserted in the apparatus as long as each tube is under the influence of the magnetic field.

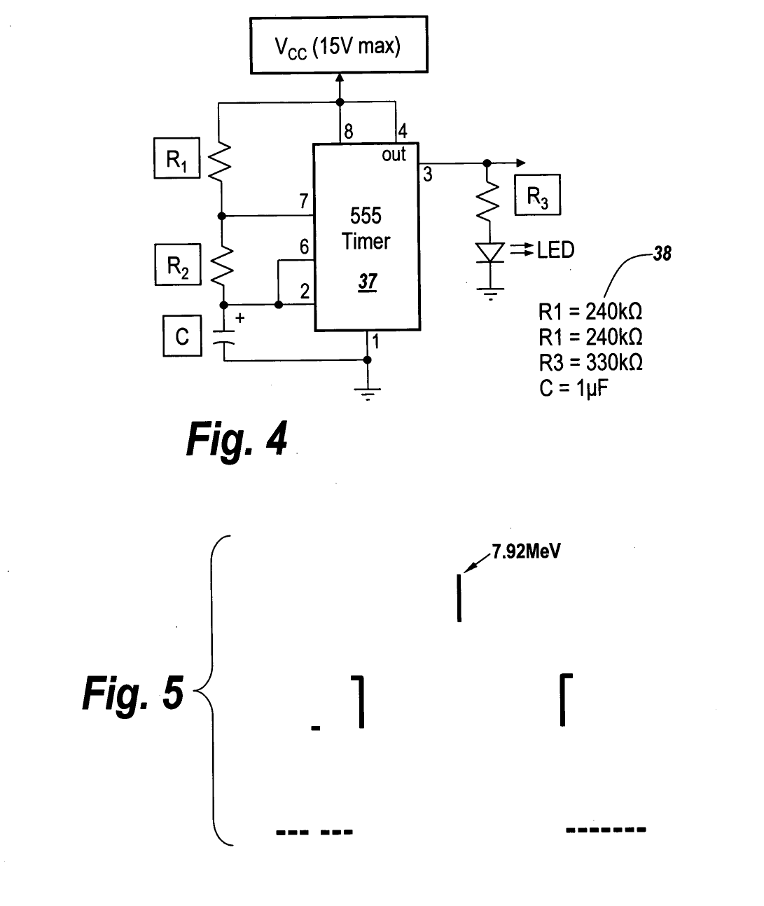

Referring now to FIG. 4, a circuit design is presented that can provide a low frequency signal mainly due to the arrangement of specific resistors and capacitors 38 and a 555 timer 37. The circuit is mentioned previously and is illustrated as 32 in FIG. 3. FIG. 4 produces a 2 Hz square wave. A different frequency can be produced by altering the values of the resistors and capacitor 38. Also, sine waves were found effective for the invention. Components as an IC socket can be incorporated, as at 37 under the 555 timer, to allow for the insertion of wires for increasing the number of antennas carrying the low frequency signal from the circuit. Moreover, binding posts allow for the connection of alligator clips to carry frequency away from the circuit. The circuit can be plugged in a power outlet by including a power cord and adaptor or a battery holder can be attached to the circuit to provide the electromagnetic energy to the invention by battery power if a power outlet is unavailable;

Referring now to FIG. 5, data collected with a Germanium detector is presented. This figure represents the energy that was released and picked-up with a Ge detector when Copper-63 (Cu-63) was placed in the holding vessel. The result was the production of Cu-64 that is concluded by the detection of 7.92 MeV: Cu-63+n→Cu-64, 7.92 MeV. The cursor of the Genie 2000 software used for detections was place on the point representing the 7.92 MeV reading. The isotope was produced with the graphite tube and the alligator clips. The result suggests the production of free neutrons that combined with the inserted Cu-63 powder in the sulfuric acid. Since free neutrons were not thought to exist initially in the tube and since the 7.92 MeV was not found in any control trials, e.g. running the detector with the invention not in front of it or with other set-ups of the invention, the reading is a direct result of producing neutrons that entered the nuclei of Cu-63 atoms to produce Cu-64. The production was achieved using the 2000 Gs magnet with 2 Hz.

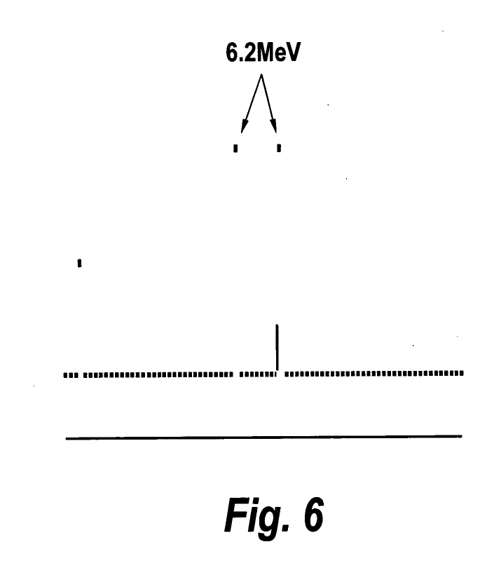

Referring now to FIG. 6, the 6.2 MeV measurement was recorded with a Ge detector when only the subatomic particle source, the sulfuric acid, was in the graphite tube when using the invention set-up of FIG. 2. The detection indicates the production of Li-6: d+He-4→Li-6, 6.2 MeV. The production was achieved using a 1000 Gs magnetic field with 3 Hz. The data further confirm the ability of the subject invention to produce neutrons that enter nuclei, as for the production of d and for the creation of He-4. In other words, from previous examinations and control trials, He-4 had to have been produced, which is explained by neutron capture: He-3+n→He-4. The data suggests that not only neutron capture is possible with the invention.

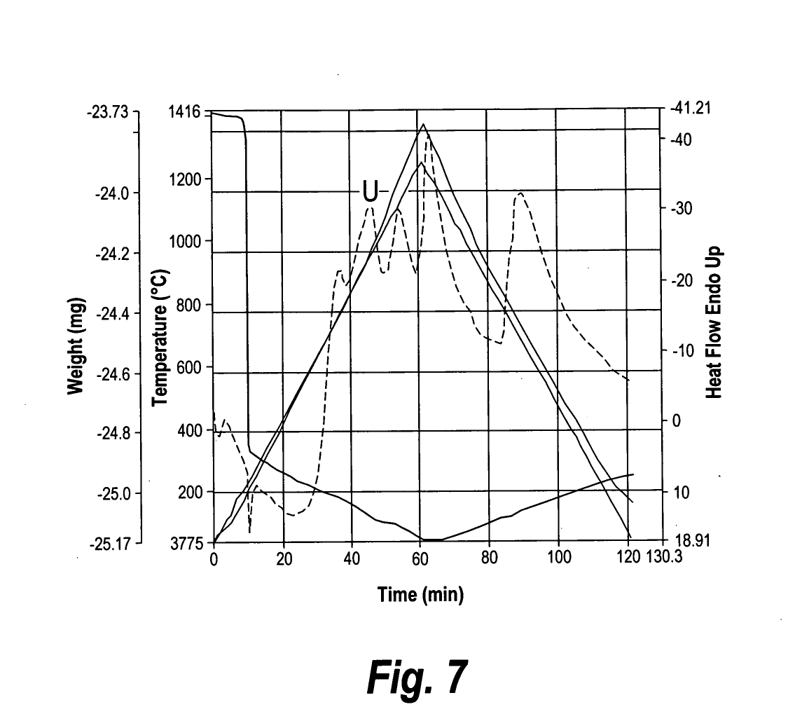

Referring now to FIG. 7, data is presented from a Differential Thermal Analysis (DTA) machine. An isotope sample produced by the subject invention was placed in the DTA machine, and the result was the detection of Uranium (U). The original element placed in the apparatus was Tungsten powder with the same subatomic particle source, the sulfuric acid. FIG. 7 demonstrates that the invention is not limited to production of elements low on the periodic table or restricted to the production of only isotopes of the same element.

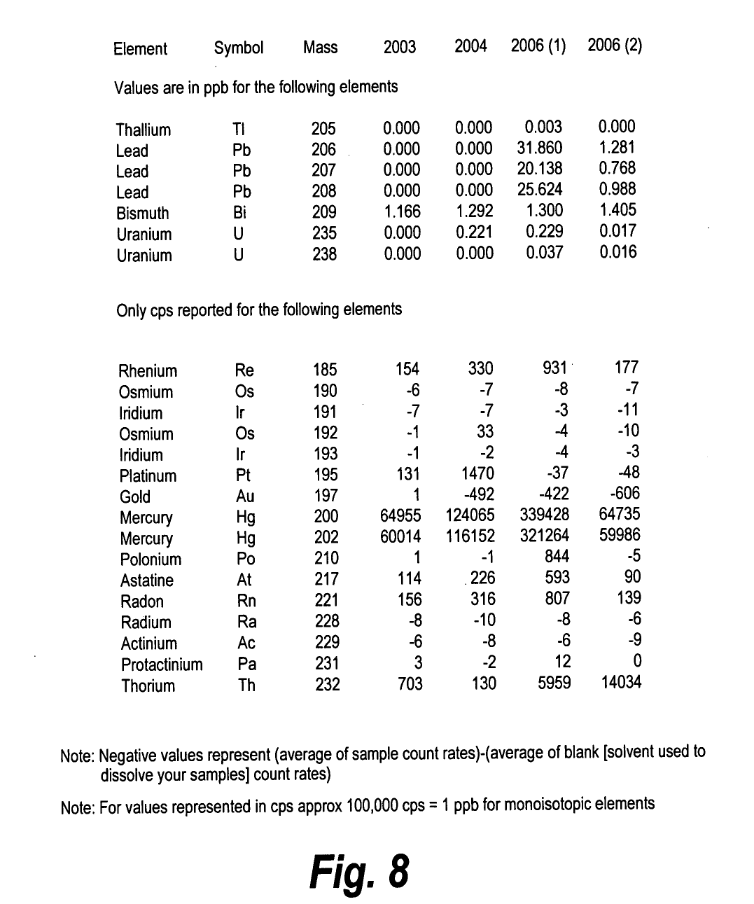

Referring now to FIG. 8, an independent lab at the Massachusetts Institute of Technology (MIT) examined powder that was taken as a result of the subject process that used only Tungsten powder as a starting material. The MIT lab detected a wide range of isotopes in samples, isotopes that were not originally in the Tungsten powder. Data from the lab is presented as FIG. 8. The 2006 (1) column is data from a sample provided after having used a Pyrex tube, which appeared to be more effective in producing isotopes than a sample 2006 (2) that was produced in a tube made of less neutron reflective material. The samples 2003 and 2004 are what remained from trials in 2003 and 2004 and were used partly as additional control examinations, e.g. to observe lack of certain isotopes due to half-lives.

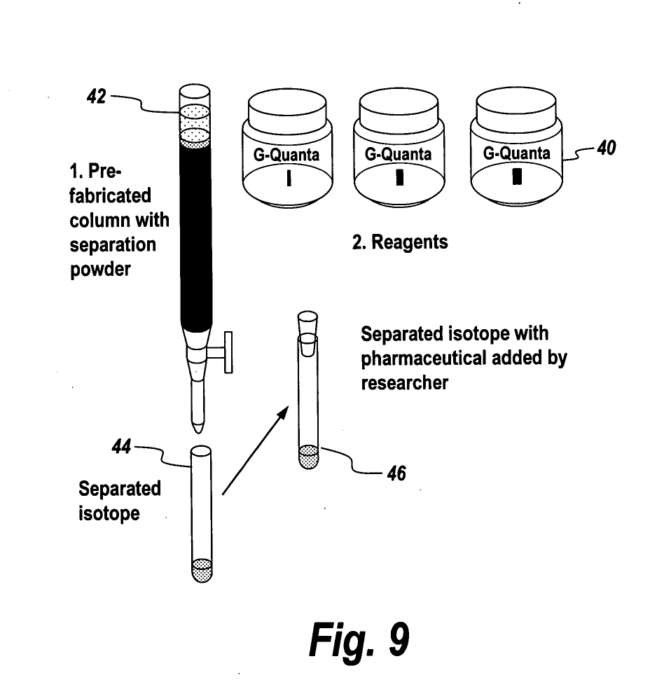

Referring now to FIG. 9, a separation technique is shown for particles and bodies that are taken from the subject apparatus. A separation column with separation powder is shown 42 that is used to isolate a specific body or particle from a collection of particles or bodies produced by the subject process. For example, a separated isotope 44 can be used for specific purposes, including being modified, e.g. by adding a specific pharmaceutical 46, to be used for a particular purpose. The separation involves removing the particles or bodies produced by the subject process, inserting them in column 42 and washing the particles through the separation column with reagents 40 or specific compounds to separate the desired particle. Different separation techniques can be used for isolating specific bodies produced by the subject invention and FIG. 9 only presents one embodiment of a separation technique.

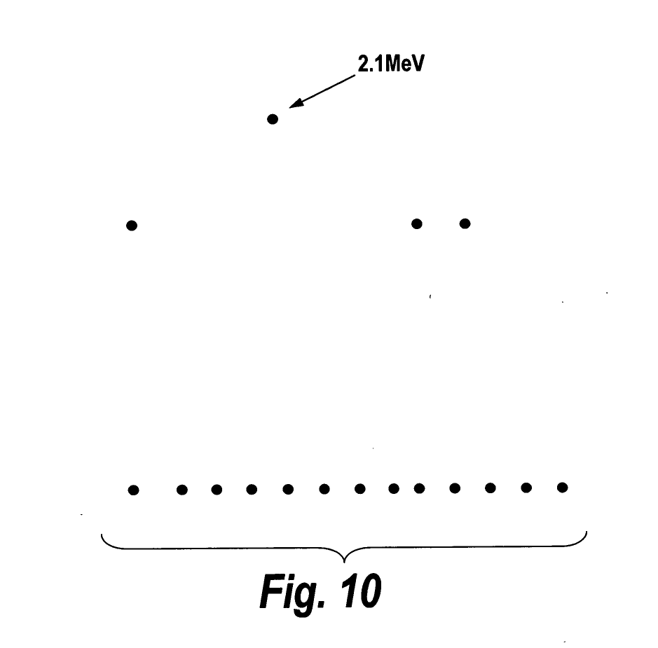

Referring now to FIG. 10, the 2.1 MeV measurement was recorded with a Ge detector and represents the production of Helium-4: n+Li-6→He-4, H-3. The isotope was produced with only the subatomic particle source in the graphite tube, the magnetic field being 1000 Gs, and the frequency was 3 Hz.

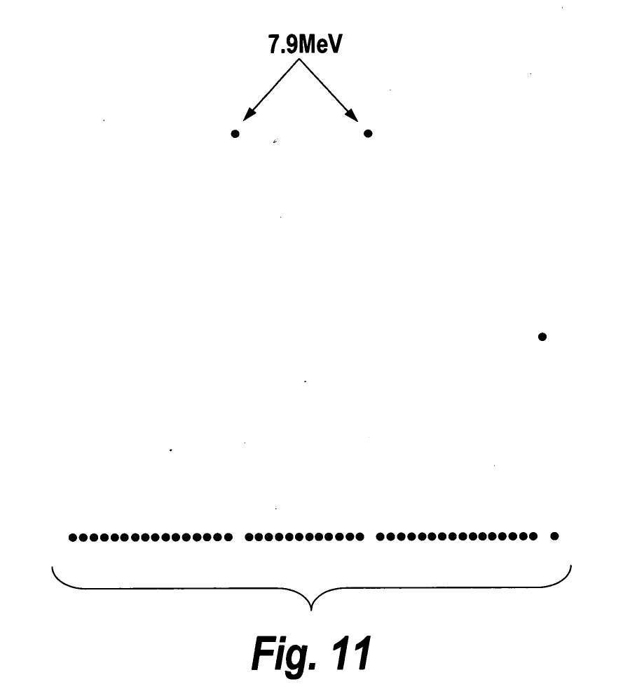

Referring now to FIG. 11, the 7.9 MeV measurement was recorded with a Ge detector and represents the production of Oxygen-18: O-17+n→O-18. The isotope was produced with only the subatomic particle source in the graphite tube, the magnetic field being 1000 Gs, and the frequency was 3 Hz. Specifically, the C-12 from the graphite tube would leak and mix with the subatomic particle source creating a scenario as though Carbon-12 had been added manually to the medium. Thus, isotopes were created due to the immersed, initial C-12 atoms interacting with primarily neutrons produced from the subatomic particle source. The result indicates that the invention can be used to produce nuclear reactions with non-metal atoms.

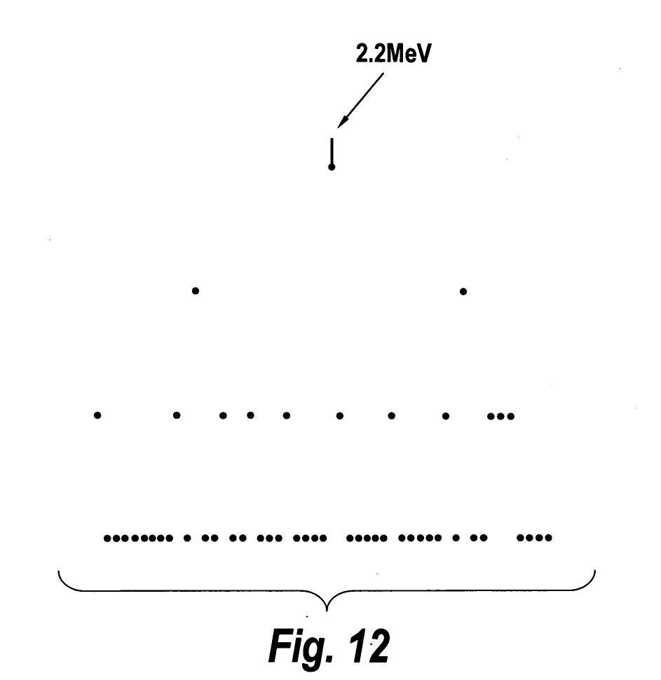

Referring now to FIG. 12, the 2.2 MeV measurement was recorded with a Ge detector and represents the production of deuterium (d): n+p→d, γ. The isotope was produced with only the subatomic particle source in the graphite tube, the magnetic field being 2000 Gs, and the frequency was 2 Hz. The detection demonstrates that the subatomic particle source, concentrated sulfuric acid, released free neutrons for nuclear reactions. Also, a MIT specialist on energy from nuclear reactions confirmed to the inventor that a 2.2 MeV reading was evidence of neutron production.

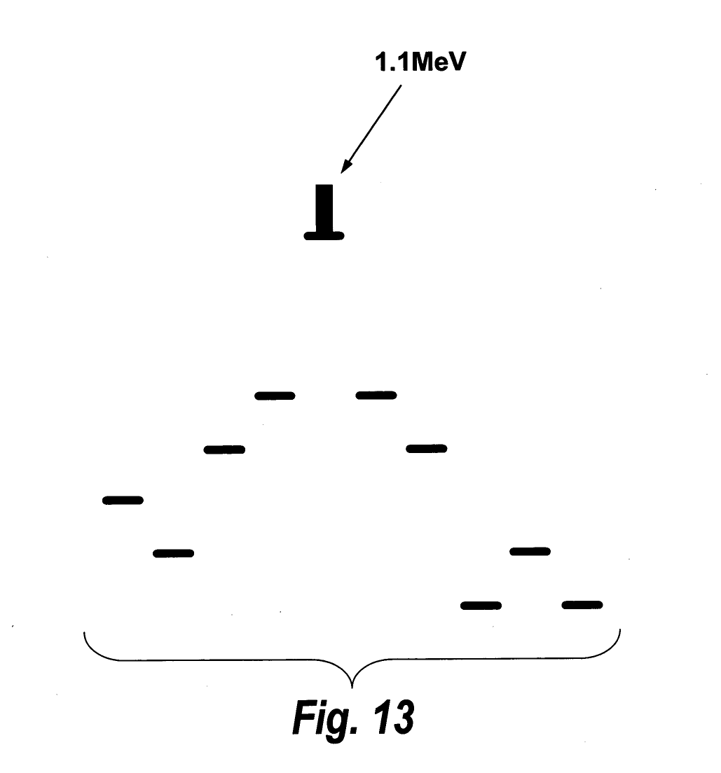

Referring now to FIG. 13, the 1.1 MeV measurement was recorded with a Ge detector and represents the binding energy per nucleon for deuterium. The isotope was produced with only the subatomic particle source in the graphite tube, the magnetic field being 2000 Gs, and the frequency was 4 Hz. The detection demonstrates that 2 Hz was a fundamental frequency since 4 Hz can also produce nuclear reactions with the 2000 Gs magnetic field.

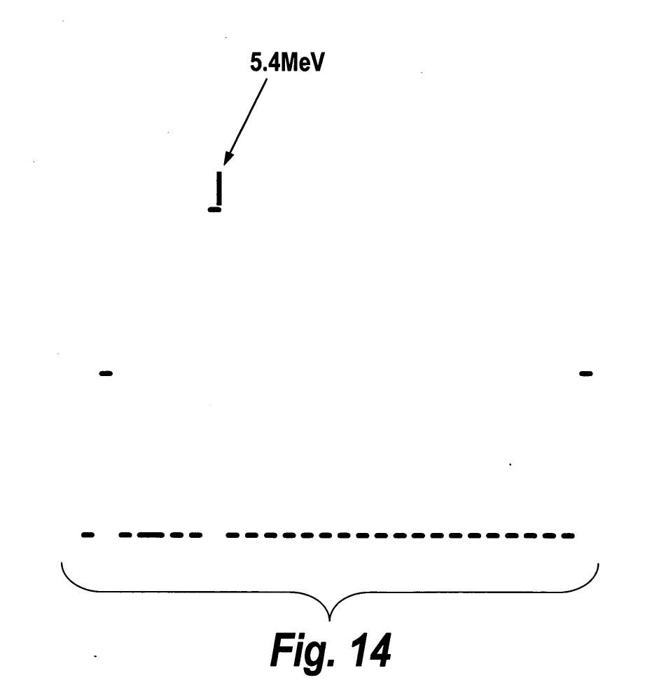

Referring now to FIG. 14, the 5.4 MeV measurement was recorded with a Ge detector and represents the production of Helium-3: d+p→He-3, γ. The isotope was produced with only the subatomic particle source in the graphite tube, the magnetic field being 2000 Gs, and the frequency was 4 Hz. The detection demonstrates in connection with FIG. 13 that a path of production occurred. In other words, the production of deuterium as evidenced with FIG. 13 was first produced that led to the creation of the He-3 of FIG. 14.

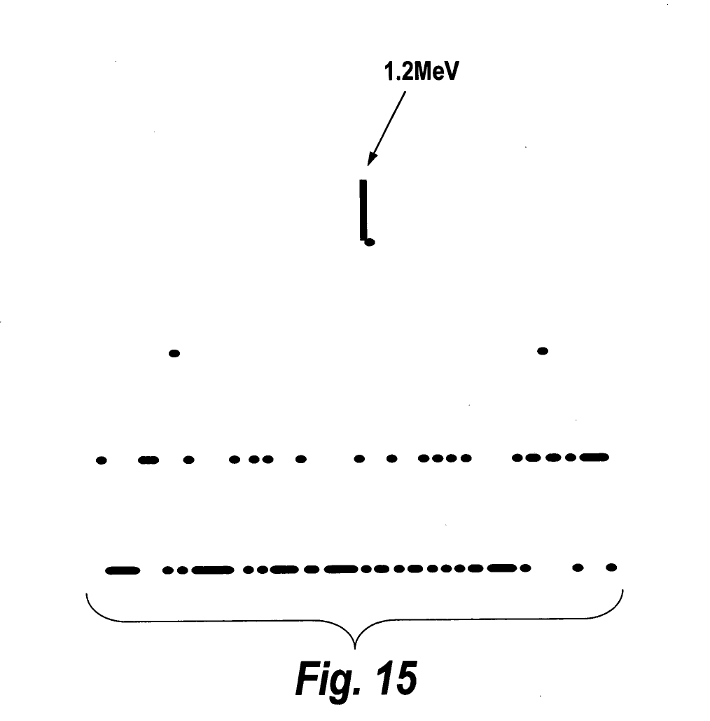

Referring now to FIG. 15, the 1.2 MeV measurement was recorded with a Ge detector and represents the decay of Nitrogen-13: N-13→C-13, e⁺. The half-life for N-13 is 9.965 minutes. The detections of 1.2 MeV corresponded to the half-life. The isotope was produced with only the subatomic particle source in the graphite tube, the magnetic field being 2000 Gs, and the frequency was 2 Hz. The N-13 is understood to have been produced from the graphite (C-12) that was observed to have leaked from the tube and became immersed in the subatomic particle source.

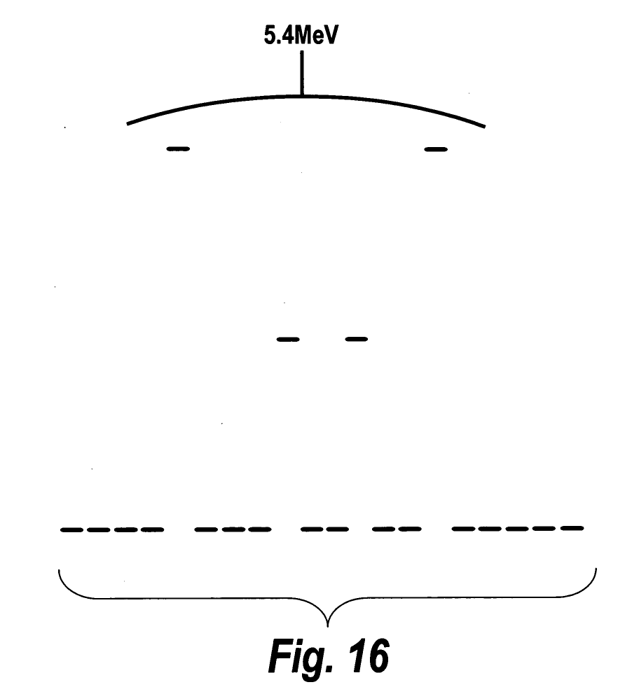

Referring now to FIG. 16, the 5.4 MeV measurements were recorded with a Ge detector and represent the production of Helium-3: d+p→He-3, γ. The recordings occurred over several channels or bins of the detector, which is why more than one point is labeled 5.4 MeV. The isotope was produced with only the subatomic particle source in the graphite tube, the magnetic field being 1000 Gs, and the frequency was 2 Hz. The detection demonstrates that a different magnetic field strength can be influential for the production of bodies.

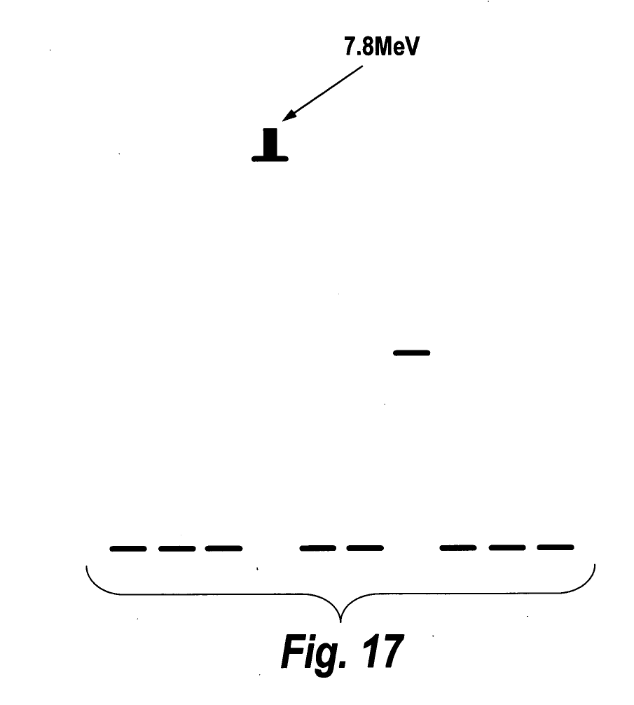

Referring now to FIG. 17, the 7.8 MeV measurement was recorded with a Ge detector and represents the binding energy per nucleon for C-12. The reading occurred when using only the subatomic particle source in the graphite tube, the magnetic field being 2000 Gs, and the frequency being 5 Hz. The detection meant that reactions involving C-12 occur, i.e. nuclear reactions happened. Also, the result further showed that 2 Hz was a fundamental frequency and that overtones or harmonics of it, e.g. 5 Hz, can lead to nuclear reactions.

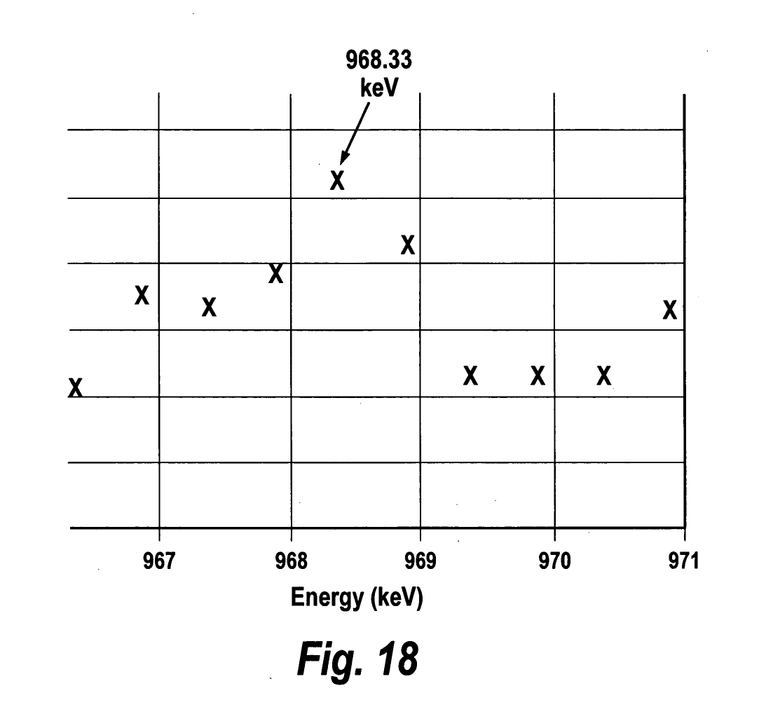

Referring now to FIG. 18, the 968.33 keV measure represents the output from a Germanium detector when a powder sample that was taken as a result of the subject process that used only Tungsten (W) powder as a starting material was placed in front of the detector. The energy reading represents the detection of the isotope Pt-199. The Xs are inserted to visualize better the measure, which was obtained with a different Ge detector than Ge detector data in other figures. The magnetic field for the invention was 2000 Gs, the frequency was 2 Hz, and a Pyrex tube was used.

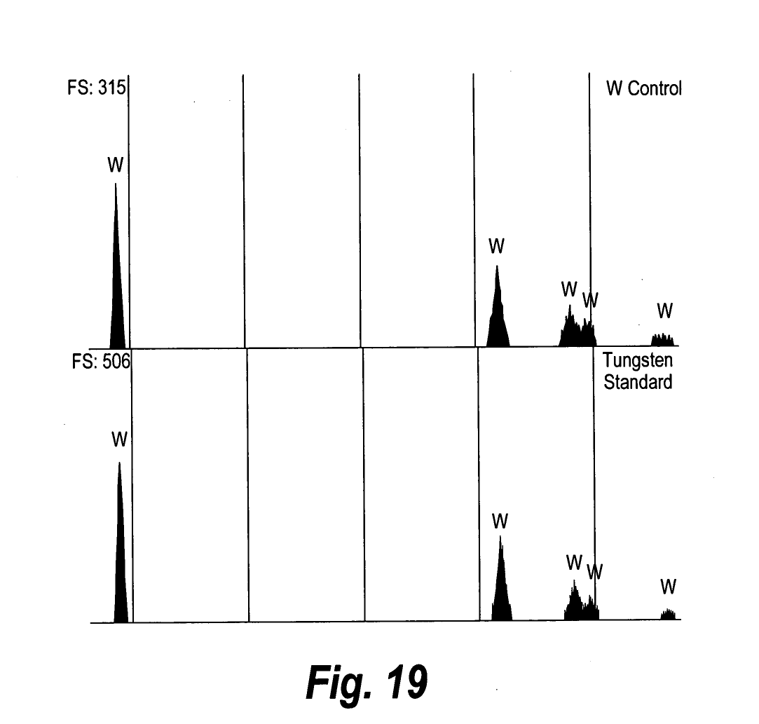

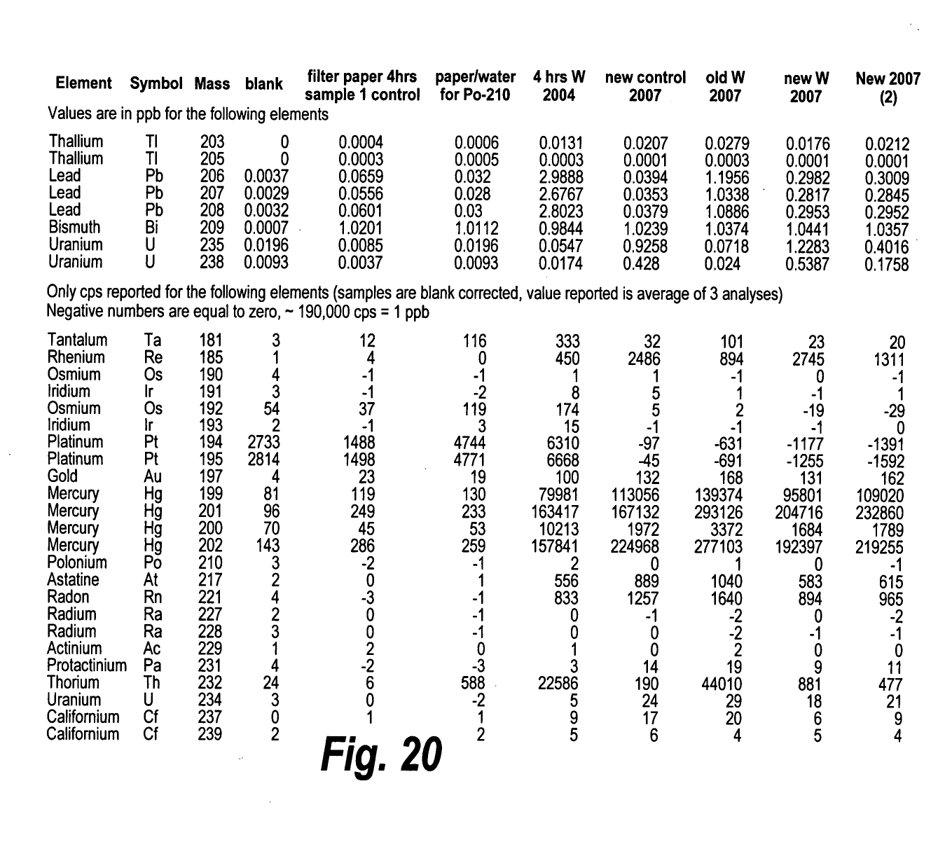

Referring now to FIG. 19, the graph is an Energy Dispersive Spectroscopy (EDS) output comparing the W used for trials (W Control) and a known pure W (Tungsten Standard). The graph shows that the W powder used for trials did not have contaminants that would raise questions about presented data. W Control and Tungsten Standard were similarly identified so that W Control being contaminated with other elements was discounted.

What is claimed is:

1. A method for generating nuclear reactions, comprising the steps of:
positioning a subatomic particle source in a holding vessel;
placing the vessel in a magnetic field;
inserting atoms or other bodies in the subatomic particle source; and
subjecting the subatomic particle source to low frequency electromagnetic energy.

2. The method of claim 1, wherein the subatomic particle source is a strong acid.

3. The method of claim 1, wherein the subatomic particle source provides protons.

4. The method of claim 3, wherein the protons/Hydrogens become neutrons when subjected to low frequency energy.

5. The method of claim 1, wherein the holding vessel is a neutron reflector.

6. The method of claim 1, wherein the subatomic particle source serves as a moderator.

7. The method of claim 1, wherein the frequency electromagnetic energy is provided through an antenna.

8. The method of claim 1, wherein the electromagnetic frequency is provided to the subatomic particle source without being in direct contact.

9. The method of claim 8, wherein the frequency is delivered to the medium with use of the holding vessel.

10. The method of claim 9, wherein the holding vessel is a conductor.

11. The method of claim 1, wherein the energy directed on the subatomic particle source is direct current.

12. The method of claim 1, wherein particles, the generation of new bodies including isotopes, and/or the release of energy results.

13. The method of claim 12, wherein the isotopes are of the same element initially inserted in the subatomic particle source.

14. The method of claim 12, wherein the produced isotopes are different from the initial elements inserted in the subatomic particle source.

15. The method of claim 12, wherein the creation of bodies is due to neutron capture.

16. The method of claim 1, wherein the frequency and/or amplitude varies depending on how the energy or current is supplied to the subatomic particle source.

17. The method of claim 1, wherein the frequency and/or amplitude varies based on the type of holding vessel and the type of subatomic particle source.

18. The method of claim 1, wherein the frequency and/or amplitude varies based on the inserted bodies that are to interact with components of the subatomic particle source.

19. The method of claim 1, wherein the frequency and/or amplitude varies based on the magnetic field strength.

20. The method of claim 1, wherein the inserted bodies or atoms that will interact with components of the subatomic particle source are directly immersed in the source.

21. The method of claim 20, wherein the inserted bodies or atoms are held in capsules or a similar compartment while immersed in the subatomic particle source.

22. The method of claim 20, wherein a lower neutron flux permits the creation of particles, bodies, or isotopes due to the initial bodies or atoms being immersed in the subatomic particle source.

23. The method of claim 1, wherein the apparatus is portable.

24. The method of claim 1, wherein the apparatus is considered an alternative energy source.

25. The method of claim 1, wherein the energy produced is incorporated in present electricity generation plants.

26. The method of claim 1, wherein the energy produced is used to power conveyance means.

27. The method of claim 1, wherein the apparatus is used to provide heat.

28. The method of claim 1, wherein biological structures can be immersed in the subatomic particle source to be altered to new structures for the same or different functions.

29. The method of claim 12, wherein the energy produced is used to fight diseases, for medical treatments, and/or for cosmetic reasons.

30. The method of claim 12, wherein the produced energy can be used for gene therapy or to produce favorable mutations.

31. The method of claim 1, wherein the apparatus can be used for nanotechnology.

32. The method of claim 12, wherein the energy is nuclear based.

33. The method of claim 12, wherein the energy is particle based.

34. The method of claim 1, wherein the apparatus can be used for tissue engineering.

35. The method of claim 1, wherein superconductivity is created.

36. The method of claim 1, wherein the apparatus is used for waste management.

37. The method of claim 1, wherein the apparatus is used for recycling, whereby materials can have spent components replaced if it can be provided by the subatomic particle source.

38. The method of claim 1, wherein the apparatus can be used for computing, quantum computing, and/or can produce materials for computing by creating particles that can be used directly for bit communications and/or can be added to computer components for improved functionality.

39. The method of claim 1, wherein the apparatus can be used for food processing.

40. The method of claim 12, wherein the energy is chemistry/bond based.
